(19) United States
(12) Patent Application Publication
(10) Pub. No.: US 2003/0191945 A1
(43) Pub. Date: Oct. 9, 2003

(54) System and method for secure credit and debit card transactions

(75) Inventor: Winston Donald Keech, Little Beck (GB)

Correspondence Address: GREENBERG-TRAURIG, 1750 TYSONS BOULEVARD, 12TH FLOOR, MCLEAN, VA, 22102, US

(73) Assignee: Swivel Technologies Limited, Knaresborough (GB)

(21) Appl. No.: 10/131,489

(22) Filed: Apr. 25, 2002

(30) Foreign Application Priority Data
Apr. 3, 2002 (GB) 0207705.5

(51) Int. Cl. H04L 9/00

(52) U.S. Cl. 713/182; 705/64

(57) ABSTRACT

There is disclosed a method and system for conducting secure credit and debit card transactions between a customer and a merchant. The customer is issued with a pseudorandom security string by a host computer, the security string being sent to the customer's mobile telephone. A cryptographic algorithm running in a SIM card of the mobile telephone performs a hash on the security string or the One Time Code extracted from the security string, a customer PIN and a transaction amount, these last two items being entered by way of a keypad of the mobile telephone. A three-digit response code is generated by the algorithm and then passed to the merchant. The merchant then transmits the response code, transaction amount and a customer account number (card number) to the host computer, where the pseudorandom security string and PIN are retrieved from memory. The host computer then applies the same algorithm to the security string, PIN and transaction amount so as to generate a check code, and if the check code matches the response code transmitted by the merchant, the transaction is authorised.

Embodiments of the present invention make use of existing CVV2 security infrastructure, but provide a significantly greater degree of security. Embodiments of the present invention may be used with ordinary face-to-face or telephone transactions, and also in e-commerce (web-based) and m-commerce (mobile telephone-based) transactions.

The present invention relates to a system and method for improving security in relation to credit and debit card transactions and the like.

Credit and debit card fraud (hereinafter referred to together as “card fraud”) is a growing problem, especially in on-line (“e-commerce”) transactions. The banking industry has responded to this with a short-term solution to combat fraud until more sophisticated approaches can be developed. This short-term solution is known as “CVV2” approach, and is relatively simple. The CVV2 code is a three digit decimal number, generally printed on the back of a credit or debit card by the card issuer, which is separate from the card number (“PAN” or “payer account number”) and not electronically coded onto the card by way of its magnetic strip or embedded chip (this helps to prevent the CVV2 code from being “skimmed” by a fraudster). The CVV2 code is printed on the card but not readable from the magnetic stripe. Verification is achieved by obtaining the card number from an online source and then checking it to see if the CVV2 code supplied is correct. A merchant conducting a non-cardholder-present transaction (e.g. an on-line or telephone transaction) requests a CVV2 code from the cardholder, as well as the PAN, card expiry date and a delivery address. The merchant then makes an on-line check to verify that the CVV2 code and the given cardholder delivery address correspond with the details held by the card issuer in connection with the card associated with the given PAN. Thus, a person attempting to make a fraudulent transaction requires the PAN, the cardholder address, the card expiry date and the CVV2 code, and the CVV2 approach therefore assumes that a fraudster will not initially know how to steal this information. The drawback is that the CVV2 approach is relatively easily overcome, since many techniques for stealing a PAN may be trivially extended to steal the CVV2 code and the cardholder address. At best, CVV2 is a temporary measure to slow down the growth in fraud. The infrastructure needed to support the CVV2 approach is already installed and in operation. This means that merchants' equipment (e.g. EPOS and EFTPOS terminals and the like) and computer (“IT”) systems are already designed and adapted to request a three digit decimal number as an additional security measure. Embodiments of the present invention are adapted to make use of this existing infrastructure to provide a level of anti-fraud security that is higher even than the new smartcard-based approaches.

An improved method and system for verifying an identity of a person, for example a credit or debit card holder, is disclosed in the present applicant's co-pending UK patent applications no. 0021964.2, International patent application no. PCT/GB01/04024 and U.S. patent applications Ser. Nos. 09/663,281 and 09/915,271. The method and system involves transmission of a pseudo-random string to a person's mobile telephone or the like prior to making a card transaction. The person then applies a mask code in the form of a personal identification number (“PIN”) to the pseudorandom string in a predetermined manner so as to generate a volatile one-time transaction identification code that is passed to the merchant and then on to an authentication server where it is checked against an independently calculated volatile one-time identification code so as to verify the identity of the cardholder.

According to a first aspect of the present invention, there is provided a method of authorising secure transactions between a customer and a merchant, the method comprising the steps of:

i) storing customer information including a customer account number and an associated personal identification number (PIN) on a host computer;

ii) generating a pseudorandom security string in the host computer;

iii) transmitting the pseudorandom security string from the host computer to at least one remote electronic device operated by the customer;

iv) inputting the PIN and a transaction amount into the electronic device upon the customer conducting a transaction with the merchant;

v) generating a response code in the electronic device by applying a predetermined cryptographic algorithm to the pseudorandom security string, the PIN and the transaction amount;

vi) transmitting the response code, the transaction amount and the customer account number to the host computer;

vii) in the host computer, using the customer account number to retrieve the PIN and the pseudorandom security string, and then applying the predetermined cryptographic algorithm to the pseudorandom security string, the PIN and the transaction amount so as to generate a check code;

viii) in the host computer, comparing the check code and the response code and, if they match, authorising the transaction.

According to a second aspect of the present invention, there is provided a secure transaction system for authorising transactions made between a customer and a merchant, the system comprising a host computer and at least one customer-operated electronic device, wherein:

i) customer information including a customer account number and an associated personal identification number (PIN) is stored on the host computer;

ii) the host computer generates a pseudorandom security string and transmits the pseudorandom security string to the at least one customer-operated electronic device;

iii) the electronic device receives an input from the customer comprising the PIN and a transaction amount when the customer conducts a transaction with the merchant;

iv) the electronic device generates a response code by applying a predetermined cryptographic algorithm to the pseudorandom security string, the PIN and the transaction amount;

v) the response code, the transaction amount and the customer account number are transmitted to the host computer;

vi) the host computer uses the customer account number to retrieve the PIN and the pseudorandom string, and then applies the predetermined cryptographic algorithm to the pseudorandom string, the PIN and the transaction amount so as to generate a check code;

viii) the host computer compares the check code and the response code and, if they match, authorises the transaction.

The response code generated by the electronic device is preferably displayed on a display of the electronic device and is transmitted verbally or otherwise to a merchant with whom the customer is conducting a transaction. Alternatively, the response code may be transmitted directly from the electronic device operated by the customer to an electronic device (e.g. an EPOS or EFTPOS terminal) operated by the merchant by any convenient technique (e.g. Bluetooth® or other standard communications techniques, typically using modulated electromagnetic radiation signals). Where a transaction is being conducted by way of a merchant website or the like, the response code may be entered in an appropriate field of the website for transmission to the merchant.

The response code, the transaction amount and the customer account number will generally be transmitted for authorisation to the host computer by the merchant rather than the customer, possibly by way of an EPOS or EFTPOS terminal or by way of any suitable computer device.

The electronic device is preferably a mobile telephone, personal digital assistant (PDA), a pager or a similar electronic communications device. The pseudorandom security string may be transmitted from the host computer to the electronic device by way of the short messaging service (SMS) protocol, or by any other appropriate communications protocol, including voice messaging, e-mail or other means.

In order to make use of the system and method of the present invention, a customer is first assigned and issued with a credit or debit card in the usual way. The card is printed with an account number unique to the customer. The customer then registers the card with an authentication centre which maintains the host computer, and registers the card number, a communications address for the customer's electronic device (e.g. the customer's mobile telephone or PDA number, e-mail address or the like) and a PIN. The PIN may be selected by the customer or assigned to him or her by the host computer, but is not divulged to third parties. The PIN will generally be a decimal number, often four digits in length, but may be of other lengths and may possibly be an alphanumeric string. The customer account number, communications address and PIN are stored in the host computer in association with each other. Once this has been done, the host computer transmits a pseudorandom security string to the customer's electronic device, for example by sending the pseudorandom security string to the customer's mobile telephone by way of the SMS protocol. The pseudorandom security string may be an n digit randomly generated decimal number, or may be an alphanumeric string or the like.

The system and method of the present invention may be used in an e-commerce scenario or in a more traditional shopping scenario.

In an e-commerce scenario, a customer makes a selection of goods and/or services from a merchant website in the usual manner. When reaching a check-out page on the website, the customer enters or otherwise provides his or her card number (customer account number) and determines a total amount to be paid. The customer then enters the total amount to be paid, together with his or her PIN, into the electronic device, and these are then hashed with the pseudorandom security string by the predetermined cryptographic algorithm or hashed with the One Time Code extracted from the pseudorandom security string by the predetermined cryptographic algorithm so as to generate the response code. In a particularly preferred embodiment, the response code is a three digit decimal number of the same format as existing CVV2-type codes printed on the back of known credit or debit cards. However, the response code may be of arbitrary length and may be non-decimal or an alphanumeric string, depending on the nature of the cryptographic algorithm used. There are many types of suitable algorithms that can perform a hashing function on the three inputs so as to generate an appropriate response code, as will be apparent to those of ordinary skill in the art, and the present application is therefore not concerned with the specifics of such algorithms. By way of exemplification, however, the standard well-known SHA-1 cryptographic hash [FIPS PUB 180-1] algorithm may be used to produce a 160-bit value, the remainder then being determined when dividing this by 1000.

Where the electronic device is a mobile telephone, the cryptographic algorithm may be stored on the telephone's SIM (“Subscriber Interface Module”) card or possibly in a separate memory device forming part of the mobile telephone. The cryptographic algorithm preferably runs as an applet in the SIM card, taking the pseudorandom security string received by the telephone as one input, the total amount to be paid as a second input and the PIN as a third input. The second and third inputs may be made manually by way of a keypad provided on the mobile telephone in the usual manner. It will be apparent that the cryptographic algorithm may run on any appropriate electronic device (e.g. a PDA, pager, personal computer etc.) in a similar manner, using standard memory and processing devices. After the response code has been calculated by the algorithm, it may be displayed on a display of the electronic device. The customer may then enter the response code in an appropriate data entry field of the merchant website (this may be a data field currently adapted for entry of a standard CVV2 code), and then take the appropriate action to cause the customer account number, the transaction amount and the response code to be transmitted to the merchant in the usual manner by way of a webserver operated by the merchant. Additional security information, such as a card expiry date and a customer address may also be provided.

The merchant can then obtain authorisation for the transaction from the card issuer in the usual way, by passing on the customer account number, the transaction amount, the response code and any other security information to a verification server operated by the card issuer. The verification server can determine from the customer account number that the card in question has been registered with the host computer forming part of the present invention, and can then contact the host computer to pass on the customer account number, transaction amount and response code.

The host computer, upon receiving this information, then uses the customer account number to retrieve the pseudorandom security code initially issued to the customer's electronic device, and also the customer's PIN, since both of these are stored in the host computer. It is then a simple matter for the host computer to run the same predetermined cryptographic algorithm as used in the electronic device, operating on the pseudorandom security string, the transaction amount and the customer's PIN so as to generate the check code. The host computer then compares the check code with the received response code to see if they match and, if they do, then contacts the card issuer's verification server to report that the transaction is authorised. The card issuer can then debit the customer's card and credit the merchant's account in the usual manner.

If the check code and the response code do not match, then the transaction is not authorised, and the card issuer's verification server can then deny the transaction. If more than a predetermined number (for example, three) transaction attempts initiated in relation to a particular customer account number fail the authorisation procedure, then the customer account number may be blocked by the host computer and, optionally, the card issuer's verification server, since repeated authorisation failure is an indication that the card has been stolen and is being used by an unauthorised person without knowledge of the customer's PIN or the pseudorandom security string. The customer account number may be unblocked only upon further communication between the customer/cardholder, the card issuer and/or the authentication centre, which may result in the customer being issued with a new card with a new account number.

If the transaction is authorised by the host computer, the host computer then generates a new pseudorandom security string and transmits this to the customer's electronic device as before. The customer may then make a further transaction, with the same or a different merchant, in the same manner. However, because the pseudorandom security string is different for each transaction, it is very difficult for a fraudster or hacker to make use of any intercepted communications to try to break the system. The new pseudorandom security string may be transmitted as part of a message including further information, such as details of the most recent transaction, an account balance, remaining credit limit and the like.

The present invention operates in a very similar manner when used in a traditional transaction scenario, for example where a customer makes a purchase in a shop or store, or makes a transaction by telephone. In this scenario, instead of interfacing with the merchant by way of a website, the transaction is conducted face-to-face or over the telephone. When a customer wishes to make a purchase, he or she asks the merchant for the total transaction amount, enters this into the electronic device together with the PIN, and then passes the computed response code to the merchant. The customer also passes the customer account number and optional security details (e.g. card expiry date) to the merchant, generally by way of handing over the credit or debit card to the merchant for passing through an electronic card reader such as an EPOS or EFTPOS machine. The computed response code may be given to the merchant verbally, or may be transmitted electronically from the electronic device directly to the EPOS or EFTPOS machine, for example. The merchant then uses the EPOS or EFTPOS machine or the like to transmit the customer account number, the transaction amount and the response code to the verification server operated by the card issuer in the usual manner, and the verification and authorisation process proceeds as before.

Even where the merchant does not have an EPOS or EFTPOS terminal, the system and method of the present invention may still be implemented in a convenient manner. It is well known that card authorisations may be made by a merchant by way of telephoning a verification centre and verbally passing over details of a customer account number and transaction amount. Accordingly, it is easy for the merchant to do this as usual, also providing the response code handed over by the customer. Authorisation and verification can then proceed as before.

In order to set out some of the advantages of the present invention, a number of security issues will now be explored with reference to existing card verification protocols.

Card Skimming:

This attack on security involves a criminal obtaining a credit card (customer account) number (perhaps by hacking a merchant's website or by picking up a discarded transaction receipt bearing the number) and then attempting to run a fraudulent transaction. This attack has a low chance of success in the present invention since the criminal has to guess a valid response code (for example, there is a 1:1000 chance of guessing a three digit decimal response code successfully). After a predetermined number (e.g. three) of failed attempts to run a transaction, the host computer blocks the card (possibly informing the cardholder via an SMS message or the like) and notifies the card issuer. The card issuer can then enter into a dialog with the cardholder to unblock the card.

Man-in-the-Middle:

This attack involves a criminal obtaining the credit card number and a valid response code. For example, the criminal might be a waiter in a restaurant (or a subverted web site) and gain access to the customer's card number and response code. The criminal waiter can run a fraudulent transaction for the same value that the customer has authorised, but the genuine transaction cannot succeed. This means that the criminal waiter can run a single fraudulent transaction for goods that total exactly the same value as the restaurant meal, but that the restaurant transaction will fail. This fraud is easily detected (the restaurant owner will soon notice the missing money) and hence is an unlikely scenario.

Shoulder-Surfing:

This attack involves a criminal looking over the shoulder of a cardholder and seeing the keys pressed by the customer on the electronic device, thereby obtaining the customer's PIN. In order to run a fraudulent transaction successfully, the criminal needs the credit card number and also needs to be in possession of the cardholder's electronic device (e.g. mobile telephone). This is a physical crime: the criminal needs to see the PIN then steal the credit card and the electronic device. It is overcome by improved PIN security and/or by advising the cardholder of relevant security issues (for example, the cardholder should never keep the card and the electronic device together and should never let anyone else see the PIN being entered).

Response Code Calculation:

This attack involves a criminal obtaining the credit card number and then calculating a valid response code. In order to calculate a response code, the criminal needs to know both the PIN and the current pseudorandom security string. The approach to inferring the PIN relies on obtaining a number of response codes, perhaps by subverting a web site frequented by the targeted cardholder. However, to infer the PIN requires knowledge of the security string (the string is in effect a one-time pad which consists of a block of random numbers in a tear-off pad, a sheet then being torn off for each message, this being an encryption technique known to be wholly secure). To obtain the security string, the criminal needs to attack the encryption on the GSM network, to attack the host computer directly, or to attack the link between the host computer and an associated SMS message centre (SMC) of a mobile network operator. In order to mount a successful response code calculation attack, the criminal needs to be able to attack a secure infrastructure at the same time as intercepting transactions (in face-to-face or e-commerce situations). This form of attack is therefore extremely unlikely to be successful or worthwhile.

Embodiments of the present invention provide a secure method and system for verifying credit and debit card transactions, with some or all of the following advantages:

No new merchant or cardholder infrastructure is necessary. Provided merchants are running the CVV2 protocol they need not even know whether the customer's card is registered with a host computer as defined in the context of the present invention. There is no need for smartcards and hence card issuing costs are kept low.

The transaction value is secured. This means that a merchant cannot run unauthorised transactions or add hidden charges to a transaction.

The cardholder is informed of each transaction automatically by SMS message or the like.

The cardholder does require a mobile phone or equivalent electronic device. However, there is no need for a special mobile phone or device. The cardholder does require the SIM card in the telephone to be programmed with an applet including the predetermined cryptographic algorithm. Some mobile telephone operators are able to install appropriate applets using “over the air” (“OTA”) programming into existing SIMs. Applets suitable for use with the present invention can be very simple and hence need not use much space in the SIM card.

No mobile telephone coverage is required at point-of-sale. The cardholder needs to be able to receive an SMS message or the like between transactions (and thus must be in coverage between transactions).

The SIM card in the mobile telephone does not require cardholder-specific PINs, keys or certificates to be stored. Thus setting up a cardholder requires no SIM programming (other than ensuring the aforementioned applet is installed in the SIM). Thus the process of re-issuing a card (due to loss or denial-of-service attacks, for example) does not require alteration of the SIM card.

As has been discussed hereinbefore, some embodiments of the present invention require that a new pseudorandom security string is used for each transaction (in effect, the security string is a one-time pad, as previously defined. The pseudorandom security string can be delivered via an SMS message or the like after each transaction. However, in some cases it is inconvenient for the cardholder to have to wait for a new SMS message or the like in order to make the next transaction (for example, the cardholder may be in a shop that has no mobile telephone coverage yet wants to make more than one transaction). To deal with this situation, embodiments of the present invention may be adapted to allow multiple transactions.

The principle is simple: when the customer activates his or her card by registering with the host computer, a single transmission (e.g. an SMS message) is made from the host computer to the electronic device including a set of m pseudorandom security strings (where m is an integer, for example 12). The applet consumes the strings one by one for each transaction processed. In order to tell the applet in the electronic device to move on to the next security string, the cardholder may need to select a ‘confirm’ menu item (as opposed to the previously described embodiments of the invention in which the confirmation is implicitly selected by the reception of a new SMS message or the like with a single security string).

When a predetermined nth transaction (n being less than the total number of security strings m initially transmitted to the electronic device; for example, n may be 6) has been authorised by the host computer, a new message is sent from the host computer to the electronic device that contains a further set of security strings. This approach allows the cardholder to make up to m purchases without needing to receive any transmissions from the host computer, which is useful when, for example, there is no mobile telephone network coverage or the like. After each transaction a simple message can be sent from the host computer to the cardholder's electronic device to act as a confirmation and mini-statement (indicating the merchant, transaction amount, current balance and remaining credit).

There is a possibility with this approach that the applet running in the electronic device and the host computer may get out of step when a first merchant fails to process a transaction at point of sale, thereby preventing a subsequent merchant from processing a subsequent transaction. Of course, the first merchant has no motive to do this, since the transaction may later fail (for example, the user may have given over an incorrect response code). Nevertheless, this situation can be dealt with by resetting the card at the host computer (perhaps following a call from the cardholder or merchant to the authentication centre). The host computer can then send a new set of security strings to re-start the process.

When (or if) the first merchant does come to process the transaction, the host computer is very likely to be able to determine whether to accept or reject the transaction. There will have been between n and m security strings outstanding (i.e. strings that have not yet been used to validate transactions) when the re-set was triggered. The host computer has a record of these security strings and the transaction from the first merchant can be run against the oldest of the outstanding security strings to see if there is a match. There are two possibilities for a match failing: (i) the transaction has failed (it is fraudulent, or the cardholder has made a mistake, or the merchant has made a mistake), or (ii) there is more than one transaction that has not been processed immediately. In case (ii) the host computer can attempt to run the transaction against a different security string. Of course, the transaction can simply be rejected on the basis that the merchant has failed to follow the correct procedures.

Using a Mobile Telephone or the Like as an EPOS or EFTPOS Terminal

Adopting the present invention changes the security status of the information being processed in a transaction (for example, knowing the card number and the response code is insufficient for making a fraudulent transaction). This means that alternative methods of supplying the required transactional information (card or customer account number, response code, transaction amount, etc.) to the host computer can be used.

A mobile telephone or PDA or the like provides an excellent means by which a merchant may access the processing system. A transaction can be described in an SMS message or the like (using a pre-defined format) and sent to a telephone number set up by an appropriate acquiring network. The acquiring network receiving the message extracts the transactional information (inferring the merchant identity from the source telephone number of the mobile telephone or the like) and then processes the transaction in the normal way (checking credit limits, accessing the host computer, and so on). The acceptance or rejection of the transaction is sent back to the merchant via an SMS message or the like to the original mobile telephone or the like.

This approach provides a low-cost way for a merchant to be part of the card processing network, and is particularly useful for small businesses with little capital to invest. It also allows cards to be processed in areas where obtaining fixed-line infrastructure would be difficult (for example in a taxi).

For a better understanding of the present invention and to show how it may be carried into effect, reference will now be made by way of example to the accompanying drawing, in which:

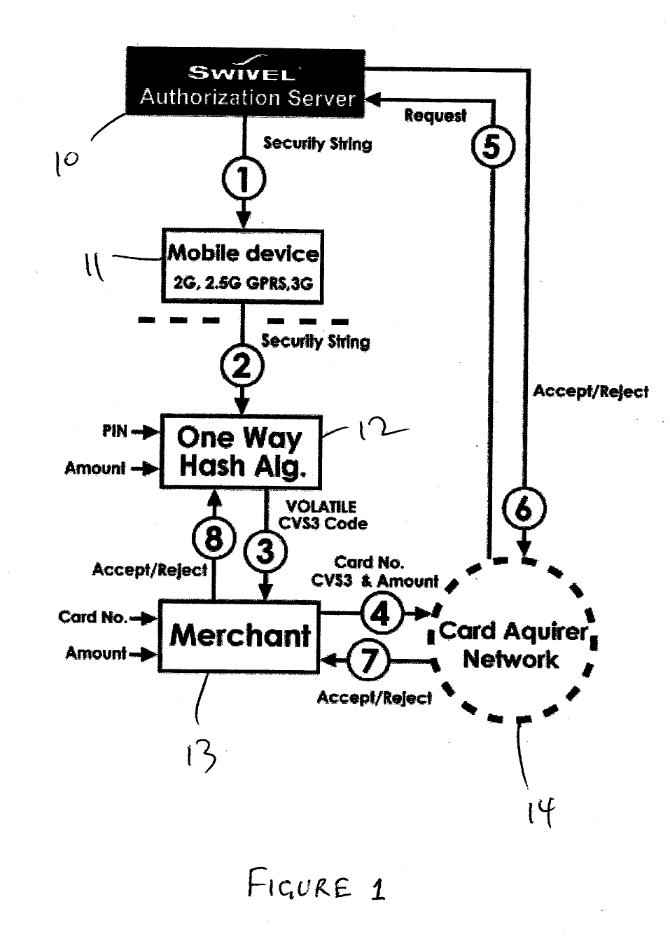

FIGURE 1 shows a schematic outline of the infrastructure of an embodiment of the present invention.

In FIGURE 1, there is shown a host computer 10 which acts as an authorisation server. When a card is issued to a customer by a card issuer, the customer must first register the card with the host computer 10, giving details of a customer account number (card number), a PIN, a mobile telephone number or the like and any other useful information, such as a customer name and address. Once this has been done, the host computer 10 generates at least one pseudorandom security string and transmits this via step 1 to a mobile communications device 11 operated by the customer, which device 11 may be a mobile telephone, PDA, pager or the like. The transmission 1 may be by way of an SMS message, e-mail or the like. The host computer 10 associates the at least one pseudorandom security string in its memory with the customer account number and the PIN.

When the customer wishes to make a transaction with a merchant 13, the customer enters a transaction amount and the PIN into the mobile communications device 11 by way of a keypad or the like. An applet running in a SIM card or the like provided in the device 11 and programmed with a one-way cryptographic hashing algorithm 12 takes the user-input transaction amount and PIN, together with the pseudorandom security string supplied via step 2, and hashes these together so as to generate a 3 digit response code that is passed to the merchant 13 by way of step 3. The response code may be given to the merchant 13 verbally in a face-to-face or telephone transaction, or by way of a merchant website when conducting an e-commerce transaction.

Meanwhile, the merchant 13 takes the customer account number and the transaction amount, possibly by way of swiping the card through an EPOS or EFTPOS terminal, or by any other appropriate means, and then passes this information, together with the response code, to a Card Acquirer Network Server (CANS) 14 in a known manner by way of step 4. The merchant 13 also transmits merchant identity information to the CANS 14 by way of step 4, thereby enabling the CANS 14 to associate the transaction with the merchant 13 as well as with the customer (by way of the customer account number).

The CANS 14 in turn passes the customer account number, transaction amount and response code to the host computer 10 in a known manner by way of step 5. The host computer 10 then uses the customer account number received from the CANS 14 to retrieve the customer PIN and the pseudorandom security string (originally transmitted at step 1 to the mobile communications device 11) from its memory, and then inputs the pseudorandom security string, the customer PIN and the transaction amount into the same one-way cryptographic hashing algorithm 12 as that running in the applet in the mobile communications device 11, except that this time the algorithm 12 is running in the host computer 10. The algorithm outputs a 3 digit check code which will match the supplied response code when the transaction is valid, since the algorithm 12 running in the host computer 10 will have operated on the same inputs as the algorithm 12 running in the applet in the mobile device 11. Accordingly, if the supplied response code and the calculated check code are found by the host computer 10 to match, the transaction is authorised, and an authorisation signal is then sent from the host computer 10 to the CANS 14 by way of step 6.

Alternatively, if the calculated check code and the supplied response code do not match, then the transaction will be rejected by the host computer 10 and a rejection signal is sent to the CANS 14 by way of step 6.

If the CANS 14 receives an authorisation signal from the host computer 10, the customer's card account is debited in the usual manner with the transaction amount, the debited transaction amount being associated with the identity of the merchant 13. In addition, the CANS 14 credits a merchant account with the amount of the transaction in the normal manner. The CANS 14 also passes an authorisation signal to the merchant 13 by way of step 7, and the merchant then notifies the customer by way of step 8 that the transaction has been authorised.

Meanwhile, once the host computer 10 has authorised the transaction, it transmits a new pseudorandom security string to the customer's mobile communications device 11 by way of step 1, together with optional information confirming authorisation of the transaction, the transaction amount and a card account balance.

If the transaction is not authorised, because the response code and calculated check code are found by the host computer 10 not to match, the CANS 14 then passes a rejection signal to the merchant 13 by way of step 7 without debiting the customer's card account or crediting the merchant's account. Upon receiving the rejection signal, the merchant 13 can refuse the transaction, or request a further response code from the customer. If the customer supplies three response codes successively that fail to match a calculated check code in the host computer 10, the host computer 10 can block the customer's account and issue a signal to that effect to the CANS 14, thus preventing further use of the card until the customer has liaised with an authentication centre operating the host computer 10. It may have been that the customer's card was stolen and is being used fraudulently by a third party without knowledge of the PIN or pseudorandom string, and a new card may need to be issued.

For further illustration of the advantages of embodiments of the present invention, a typical scenario will now be described.

Alice has decided that she wants to get a card for use with the present invention. She wants to do this for two reasons. Firstly, she wants to make sure that she can shop safely on the Internet (she has read about how easy it is for hackers to break into web sites and steal credit card numbers, names, addresses, telephone numbers, and so on). Secondly, she wants a card and no-one else will give her a card: Alice is 15 years of age and is too young to obtain a credit card. But because a card protected by way of the present invention protects the merchant 13 and the cardholder from each other's potential misbehaviour, several banks are prepared to issue pre-pay protected cards to teenagers.

While at school, Alice goes to her bank's web site (using her Internet-banking account) and asks for a card to be sent. She also tells the bank her mobile phone number (and who her mobile operator is) and chooses a PIN. She ticks the option to have a special picture on her card and uploads a digital photo from her personal computer (her card is not embossed since it is never going to be swiped over carbon paper).

The bank starts processing the request for a card. It checks that the mobile operator uses SIMs programmed with an appropriate applet for use with the present invention. The bank then creates a card for Alice and transmits the card number, Alice's PIN, and her mobile phone number to the host computer 10 operated by the independent authentication centre (the host computer 10 does not need any other information).

A few days later Alice's card arrives in the post. Alice goes to her Internet bank account to tell the bank that the card arrived. She also transfers [symbol] 150 on to the card. A few seconds later she gets (step 1) a text message on her phone 11 saying that her card is ready to be used (the message also contains twelve security strings, but she is not necessarily aware of this).

Alice goes shopping on the web, looking to buy a birthday present for her mother. She visits a web site 13 that sells gardening equipment and finds an ideal present: a gold-plated watering can. The cost is [symbol] 50.00 including postage. She goes to the ‘checkout’ page and gets out her card to pay. The site asks for the last three digits on the back of her card. On her card, the last three digits are marked ‘***’. She looks closer and notes that the card includes the words ‘use response code for ***’. She remembers reading about this in an information leaflet sent with the card. She gets out her mobile phone 11 and selects ‘Card payment’ from the menu (this activates the applet), enters (step 2) her PIN and presses the ‘OK’ key. She then keys in (step 2) the transaction amount of 50.00 and presses ‘OK’. The applet running in the SIM card of the phone 11 then applies the algorithm 12 to the PIN, the transaction amount and the security string (supplied at step 2) so as to generate a 3 digit response code, and the phone 11 then displays ‘Response code: 132’. She types ‘132’ (step 3) into the box in the web site 13 where it asks for the three digits. The web site 13 then displays ‘Processing order . . . ’.

The web merchant's server hands over the transaction details (the card number, the amount, Alice's address, and the three digit code it thinks is the CVV2 code) to a card processing computer (the web merchant is using a service company to process card transactions). This computer then looks at the card number and contacts (step 4) the appropriate Card Acquirer Network Server (CANS) 14. It hands over the same transaction details.

The CANS 14 checks that there is sufficient money on the card to make the payment. This check passes (the card account contains [symbol] 150 and the transaction is for [symbol] 50.00). The CANS 14 then calls (step 5) the host computer 10 with the card number, the amount and the three digit response code. The host computer 10 uses the card number to look up Alice's PIN and the security string that it issued to Alice's mobile phone 11. It runs the same cryptographic hash algorithm 12 that the applet in the SIM in Alice's mobile phone 11 runs (using the security string and PIN it looked up plus the transaction amount handed over by the CAN server 14). The host computer 10 works out the check code corresponding to the response code that Alice read from the display of her mobile phone: 132. The computed check code and the response code given to the host computer 10 by the CAN server 14 match, and the transaction is therefore deemed valid and authorised.

The host computer 10 tells (step 6) the CANS 14 that the security check passes and creates a new security string. The CANS 14 tells the host computer 10 the merchant 13 identity and the current balance on her card. The host computer 10 takes this information and sends it in a text message (step 1) to Alice's mobile phone 11, along with a new security string. The CANS 14 tells the card processing computer that the transaction has cleared. The card processing computer tells this to the web merchant's server 13. The web server 13 tells Alice that payment has been accepted. A few seconds later Alice gets a text message (step 1) on her mobile phone 11 from the host computer 10. The text message says ‘Presents Direct [symbol] 50.00. Balance [symbol] 100.00’.

Alice goes in to town to do some more shopping. In her favourite book shop she finds that she cannot call her friend on her mobile phone 11 because there is no signal (she thinks this is odd because there is coverage outside the shop, but she is unaware that the shop is steel-framed and clad in reinforced concrete, thereby blocking mobile phone signals). She finds the books she wants anyway and goes to pay. At the checkout, the clerk tells her that the total is [symbol] 20.55. She hands the clerk her card and then takes out her mobile phone 11. She selects ‘Card payment’ from the menu (this activates the applet) and keys in (step 2) her PIN and then presses ‘OK’. She then enters (step 2) the transaction amount of 20.55 and presses ‘OK’. The applet then takes one of the set of twelve originally supplied security strings as a third input and calculates the response code by way of the algorithm 12. The phone 11 displays ‘Response code: 451’.

Meanwhile the clerk has swiped Alice's card in an EPOS machine 13. The machine 13 reads the card number and makes a call (step 4) to the Card Acquirer Network Server 14 (CANS) used by Alice's bank. The CANS 14 at the other end of the phone call asks the EPOS machine 13 to read the transaction amount. The clerk keys in 20.55. Then the CAN server 14 asks for the response code. The clerk asks Alice for the response code, and Alice says to the clerk “451”. The clerk then enters the response code into the EPOS machine 13, and the response code is passed to the CANS 14 (step 4).

The CANS 14 checks that there is sufficient money on the card to make the payment and then calls (step 5) the host computer 10 with the card number, the amount and the response code. The host computer 10 works out the check code which should match the response code that Alice has read from the display of her mobile phone: 451. The computed check code and the response code given to the host computer 10 by the CAN server 14 are found to match, and the transaction is therefore valid. The host computer tells (step 6) the CANS 14 that the security check passes and creates a new security string. The CANS 14 tells the host computer 10 the merchant identity and the current balance on Alice's card. The host computer 10 takes this information and sends it (step 1) in a text message to Alice's mobile phone 11, along with a new security string.

The CANS 14 tells (step 7) the EPOS machine 13 that the transaction has cleared. The EPOS machine 13 displays an ‘OK’ message to let the clerk know that the transaction has cleared. The clerk hands Alice her card and a bag with her books. Alice leaves the shop and finds that it is raining hard. She decides that she will take a taxi home and crosses the street. Just as she gets to the other side, she gets a text message (step 1) on her phone 11. It says ‘Acme Books [symbol] 20.55. Balance [symbol] 79.45’. What she does not see is that the message has also put a new security string into her mobile phone 11, ready for the next time she uses her card.

When she gets to her home, the taxi driver tells her the fare is [symbol] 22.50. She tells him to take [symbol] 25.00 including tip. She hands the driver her card and selects ‘Card payment’ from the menu on her mobile phone 11, enters (step 2) her PIN and presses ‘OK’. She then keys in (step 2) 25.00 and presses ‘OK’. The phone 11 applies the algorithm 12 to the PIN, transaction amount and a security string and then displays ‘Response code: 722’. Meanwhile, the taxi driver has started to write a new text message in his mobile phone 13. He keys in Alice's card number and the transaction amount of 25.00. He then asks Alice for her response code and she says “722” (step 3). He types 722 into the message and sends it (step 4) to the CANS 14 mobile number (stored in the address book of his phone 13).

The CANS 14 receives the message. It looks up the sender's telephone number and finds that it is registered to the taxi driver (he is a one-man company). The CANS 14 checks that Alice's card account has enough money for the transaction (it has [symbol] 79.45 and the transaction amount is [symbol] 25.00). Then the CANS 14 contacts the host computer 10 and hands over (step 5) the card number, the amount ( [symbol] 25.00) and the response code (722). The host computer 10 checks that the response code is valid by comparing it with the independently-calculated check code, and indicates success to the CANS 14 (step 6). The CAN server 14 sends (step 7) an SMS message to the taxi driver's phone 13 indicating that the transaction has succeeded and tells the host computer 10 the merchant identity and the new card balance ( [symbol] 54.45).

The taxi driver receives (step 7) a text message from the CANS 14 saying ‘Transaction authorised’. He tells Alice the payment is OK (step 8) and she gets out of the taxi. A few seconds later she gets a text message (step 1) on her mobile phone 11 that says ‘John's Taxicabs [symbol] 25.00. Balance [symbol] 54.45’. Alice goes into her house.

The next day Alice is in town when she realises that her card is missing. The taxi driver must have forgotten to hand the card back to her. She calls her bank to tell them. They tell her that there is no problem, and that they will send another card to her home immediately. The next day a new card arrives in the post. The bank does not bother to change the card number or create a new PIN for Alice. The bank knows that it is not possible for a criminal to make payments with the old card. Alice is pleased: she does not want the trouble of changing all her card details or having to remember a new PIN. The bank is happy too: they do not have to do any work other than print another copy of the card and put it in the post.

Embodiments of the present invention are therefore a major improvement over the existing CVV2 protocol. They provide protection against fraud for all parties. For example, cardholders are protected from errant merchants (or their staff), and merchants are protected against stolen cards or fraudulent cardholders.

As well as eliminating card fraud (to the benefit of the card issuers and the merchants), embodiments of the present invention provide direct benefits to the cardholder: replacing a lost or stolen card is not tiresome, and close scrutiny of card statements is not essential.

The security properties of embodiments of the present invention open up possibilities for further development in the infrastructure area. For example, the use of mobile telephones as a low-cost and simple way of introducing merchant facilities means that the use of cards can be extended into areas that are not feasible today (ironically, many developing countries have superb wireless telecommunications infrastructure while the fixed line infrastructure remains poor). The approach even offers the possibility for ordinary individuals to take payments to their cards (extremely useful for making high value payments for items such as second-hand automobiles or computer equipment).

One of the most important advantages of embodiments of the present invention is that these benefits can be obtained without significant infrastructure investment, thus providing a superb opportunity to reduce fraud at the same time as opening up new possibilities in the personal finance industry.

1. A method of authorising secure transactions between a customer and a merchant, the method comprising the steps of:
i) storing customer information including a customer account number and an associated personal identification number (PIN) on a host computer;
ii) generating a pseudorandom security string in the host computer;
iii) transmitting the pseudorandom security string from the host computer to at least one remote electronic device operated by the customer;
iv) inputting the PIN and a transaction amount into the electronic device upon the customer conducting a transaction with the merchant;
v) generating a response code in the electronic device by applying a predetermined cryptographic algorithm to the pseudorandom security string, the PIN and the transaction amount;
vi) transmitting the response code, the transaction amount and the customer account number to the host computer;
vii) in the host computer, using the customer account number to retrieve the PIN and the pseudorandom security string, and then applying the predetermined cryptographic algorithm to the pseudorandom security string, the PIN and the transaction amount so as to generate a check code;
viii) in the host computer, comparing the check code and the response code and, if they match, authorising the transaction.

2. A method according to claim 1, wherein the remote electronic device is a mobile telephone, personal digital assistant or a pager.

3. A method according to claim 1 or 2, wherein the response code is passed to the merchant by the customer, and the merchant then passes the response code, the transaction amount and the customer account number to the host computer in step v).

4. A method according to claim 3, wherein the response code is passed to the merchant by the customer by way of a merchant website.

5. A method according to claim 3, wherein the response code is passed to the merchant by the customer as a verbal or written message.

6. A method according to claim 3, wherein the response code is passed to the merchant by the customer as an electronic transmission from the electronic device.

7. A method according to any preceding claim, wherein the response code, transaction amount and customer account number are transmitted to the host computer in step v) by way of an intermediate server.

8. A method according to any preceding claim, wherein the response code, transaction amount and customer account number are transmitted to the host computer in step v) by way of an Internet connection.

9. A method according to any one of claims 1 to 7, wherein the response code, transaction amount and customer account number are transmitted to the host computer in step v) by way of an EPOS or EFTPOS machine operated by the merchant.

10. A method according to any one of claims 1 to 7, wherein the response code, transaction amount and customer account number are transmitted to the host computer in step v) by way of a mobile telephone, personal digital assistant or the like operated by the merchant.

11. A method according to any preceding claim, wherein a plurality of pseudorandom security strings is transmitted simultaneously from the host computer to the electronic device in step iii).

12. A method according to any one of claims 2 to 11, wherein the algorithm runs as an applet in a SIM card installed in the electronic device.

13. A method according to any preceding claim, wherein the response code and the check code are three digit decimal numbers.

14. A secure transaction system for authorising transactions made between a customer and a merchant, the system comprising a host computer and at least one customer-operated electronic device, wherein:
i) customer information including a customer account number and an associated personal identification number (PIN) is stored on the host computer;
ii) the host computer generates a pseudorandom security string and transmits the pseudorandom security string to the at least one customer-operated electronic device;
iii) the electronic device receives an input from the customer comprising the PIN and a transaction amount when the customer conducts a transaction with the merchant;
iv) the electronic device generates a response code by applying a predetermined cryptographic algorithm to the pseudorandom security string, the PIN and the transaction amount;
v) the response code, the transaction amount and the customer account number are transmitted to the host computer;
vi) the host computer uses the customer account number to retrieve the PIN and the pseudorandom string, and then applies the predetermined cryptographic algorithm to the pseudorandom string, the PIN and the transaction amount so as to generate a check code;
viii) the host computer compares the check code and the response code and, if they match, authorises the transaction.

15. A system as claimed in claim 14, wherein the remote electronic device is a mobile telephone, personal digital assistant or a pager.

16. A system as claimed in claim 14 or 15, adapted such that the response code is transmissible to the merchant by the customer, and such that the merchant can transmit the response code, the transaction amount and the customer account number to the host computer in step v).

17. A system as claimed in claim 16, further comprising a merchant website adapted to receive the response code from the customer.

18. A system according to claim 16, wherein the electronic device is adapted to transmit the response code to the merchant by way of an electronic transmission.

19. A system as claimed in any one of claims 13 to 18, further comprising an intermediate server by way of which the response code, transaction amount and customer account number are transmitted to the host computer in step v).

20. A system as claimed in any one of claims 13 to 19, adapted to transmit the response code, transaction amount and customer account number to the host computer in step v) by way of an Internet connection.

21. A system as claimed in any one of claims 13 to 19, further comprising an EPOS or EFTPOS machine adapted to transmit the response code, transaction amount and customer account number to the host computer in step v).

22. A system as claimed in any one of claims 13 to 19, further comprising a mobile telephone, personal digital assistant or the like operated by the merchant, adapted to transmit the response code, transaction amount and customer account number to the host computer in step v).

23. A system as claimed in any one of claims 13 to 22, wherein the host computer is adapted to transmit a plurality of pseudorandom security strings simultaneously to the electronic device in step iii).

24. A system as claimed in any one of claims 14 to 23, wherein the algorithm runs as an applet in a SIM card installed in the electronic device.

25. A system as claimed in any one of claims 13 to 24, wherein the response code and the check code are three digit decimal numbers.

26. A method of authorising secure transactions between a customer and a merchant, substantially as hereinbefore described with reference to the accompanying drawing.

27. A secure transaction system for authorising transactions made between a customer and a merchant, substantially as hereinbefore described with reference to the accompanying drawing.
